(19) United States
(12) Patent Application Publication
(10) Pub. No.: US 2018/0310537 A1
(43) Pub. Date: Nov. 1, 2018

(54) HOOKLESS METHODS AND SYSTEMS FOR HOLDING FISHING BAIT

(71) Applicants: Diane Lady Martin, Sevierville, TN (US); Alan Lane Martin, Knoxvile, TN (US); Alison Lady Martin, Arlington, TN (US); Fred Lane Martin, Sevierville, TN (US); Robert Murrel Creed, Arlington, TN (US)

(72) Inventors: Diane Lady Martin, Sevierville, TN (US); Alan Lane Martin, Knoxvile, TN (US); Alison Lady Martin, Arlington, TN (US); Fred Lane Martin, Sevierville, TN (US); Robert Murrel Creed, Arlington, TN (US)

(21) Appl. No.: 15/581,012

(22) Filed: Apr. 28, 2017

(51) Int. Cl. A01K 83/06; A01K 97/04; A01K 85/00

(52) U.S. Cl. CPC A01K 83/06; A01K 85/00; A01K 97/045

(57) ABSTRACT

The invention pertains to methods and systems for securing fish bait without killing, injuring, or damaging the structure of the fish bait without obscuring the bait or lure while improving the chances of catching a nearby fish. All types of bait or lures are secured by a mesh pouch in close proximity to a fish hook. The fishing hook may remain outside of the mesh pouch or be assembled inside the mesh pouch along with the bait. The bait may be live, previously live, artificial, or prepared such as cut bait or dough balls. There is no penetration of the bait by the hook so live bait tends to stay alive and active or if it is prepared, it will tend to stay in tack.

### CROSS REFERENCE TO RELATED APPLICATIONS

The present application is a continuation-in-part of co-pending U.S. Application No. 62/328,828, filed Apr. 28, 2016.

### TECHNICAL FILED

The present invention generally relates to fishing lures and bait control for the purpose of catching fish.

### BACKGROUND OF THE INVENTION

Fishing has been important to human survival, nutritional health, and recreation for thousands of years. The Chinese and Egyptians used fishing rods, hooks, and lines as early as 2,000 B.C., though most of the first fishermen used handlines. The first hooks were made out of bronze, which was strong but still very thin and not significantly visible to the fish. The Chinese were the first to make fishing line, spun from fine silk.

Fishing bait is any substance (live or not) used to attract and catch fish, e.g. on the end of a fishing hook. Traditionally, night-crawlers, worms, insects, and smaller bait fish have been used for this purpose. Traditionally and typically, to retain the bait at the proximity of the end of the fishing hook, the bait is penetrated by the sharp end of the hook at least once. This holds the bait into position so that a fish is likely to be hooked as it bites the bait. Unfortunately this form of baiting the hook causes severe damage to the bait and generally caused live bait such as a minnow to die. This penetrating method also causes some types of bait to break apart due to the fragile nature of the bait such as a cricket.

Not only does penetrating bait cause damage to the bait but it increases the likelihood of injuring the person doing the baiting of the hook in the form of puncturing the skin. The skin punctures associated with baiting a hook are painful and potentially lead to infections. It also reduces fishing efficiency by taking time away from actual fishing.

What has been needed is a way to hold the bait in place near the sharp end of the hook without damaging the bait. This improves the fishing efficiency since the bait will tend to remain alive or in tack and behave more naturally or cohesively for long periods of time in the water without having to re-bait the hook as frequently. The non-penetration need has applied to live bait, dead bait, cut bait, dough balls, or other types of bait.

Furthermore, what has been needed is a safe, simple, and easy method of baiting (near) a hook that is non-penetrating to the bait or lure itself and does not reduce the attraction from the fish to the bait. The invention disclosed provides all these attributes and is a revolutionary change in the way fishing with a rod and reel, cane pole, hand line, or trotline is performed.

### SUMMARY OF THE INVENTION

According to one embodiment of the invention, an apparatus is described for a fish bait holding apparatus includes a partially enclosed bait mesh pouch made of a seamed mesh material and having an entry port. A securing member fixated at a frontal end of the bait mesh pouch is used for attaching the pouch to a fishing hook and alternatively, a fishing hook can be placed through the mesh wall of the bait mesh pouch. According to another embodiment of the invention, an open frame apparatus includes a mechanically integrated collection of parts including a mesh dome to secure the bait at the front or mouth position and a bait harness including a ring for securing the bait harness to a fishing line, at least one connecting member for suspending the bait harness, a top and bottom set of longitudinal harness members for structural support and keeping the fishing bait elongated, and a set of C shaped rigid members for structural support and for mounting elastic members that are used in conjunction with the C shaped rigid members to secure the fish bait.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a side view of a baited mesh pouch attached to a fishing hook with the hook positioned outside of the mesh pouch

FIG. 2 is a side view of a baited mesh pouch attached to a fishing hook eye with the hook positioned outside of the mesh pouch

FIG. 3 is a side view of a form fitted or shaped baited mesh pouch attached to a fishing hook with the hook positioned outside of the mesh pouch

FIG. 4 is a side view of a baited mesh pouch attached to a fishing hook bend with the hook positioned in line with the mesh pouch

FIG. 5 is a side view of a baited mesh pouch attached to an external fishing hook by a drawstring with the hook positioned outside of the mesh pouch

FIG. 6 is a side view of a baited mesh pouch attached to a fishing hook with the hook penetrating the mesh pouch

FIG. 7 is a side view of a baited mesh pouch attached to an internal fishing hook with the hook positioned in close proximity to the bait inside of the mesh pouch

FIG. 8 is an end view of a baited mesh pouch with an internal fish hook.

FIG. 9 is a side view of a baited harness with a partial mesh pouch at the mouth of the bait.

FIG. 10 is a rear or tail end view of a baited harness with a partial mesh pouch at the mouth of the bait not shown.

### DETAILED DESCRIPTION OF THE INVENTION

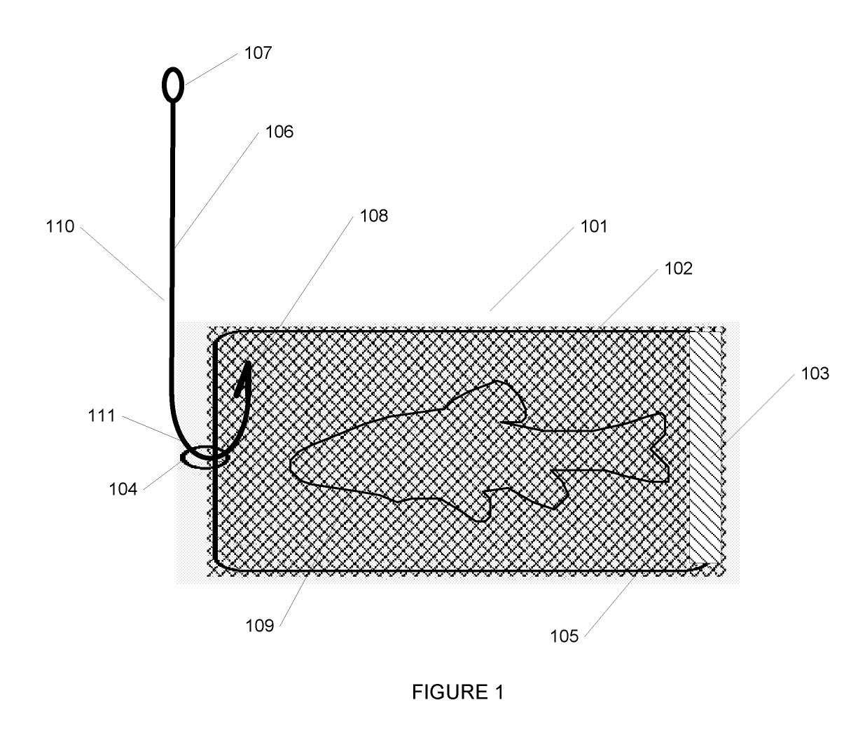

Referring to FIG. 1, a side view of fishing bait mesh pouch 101 is illustrated attached to a fish hook 110. The fish hook 110 illustrated has an eye 107, a shank 106, a bend 111, and a point/barb 108. The fish hook 110 is attached to the fishing bait mesh pouch 101 at exemplary ring 104. The fishing bait mesh pouch 101 is constructed with a mesh material 102, a seam 105 along the perimeter of the pouch 101 to shape and partially enclose the pouch 101, and an entry port 103 which faces either the rear or the front relative to the enclosed or entrapped fishing bait 109 orientation or the placement or position of the attached fishing hook. The fishing bait pouch 101 is shown with fishing bait 109 held, enclosed, or entrapped. The fishing bait 109 may be live as for example a live minnow, crocket, or worm or the bait may a shaped material such as a dough ball, artificial such as a fake minnow, or a natural entity such a a salmon egg. The fishing bait may also be dead such as a dead minnow, cricket, or worm.

With continuing reference to FIG. 1, the fishing bait mesh pouch 101 is partially enclosed with a seam 105 made by sewing an interweaved thread, a glue seam, a melted mesh seam, RF welded seam, or other seaming technique including combinations of the above means for seaming. The seam is shaped and sized along a perimeter for any shape or size of fishing bait or for a specific rectangular size and shape. The seam provides a perimeter of and for the various bait mesh pouches herein.

With continuing reference to FIG. 1, the fishing bait mesh pouch 101 and associated entry port 103 are sized and shaped to accommodate any particular fishing bait or lure 109 used for fishing. The shape as produced by the seam configured as a shape corresponding to a rectangle is shown in FIG. 1.

With continuing reference to FIG. 1, the fishing bait pouch 101 facilitates an entry port 103 that is in the form of waterproof glue, Velcro®, snap, wires, zipper, flap, wire tie, wire hook, or draw string. The entry port is used to facilitate the bait entry into the pouch 101 with retention to secure, hold, or entrap the bait.

With continuing reference to FIG. 1, the fishing bait pouch 101 is composed of a mesh that is flexible or stretchable so the bait 109 appears and feels as unobstructed. Furthermore, the mesh is optionally clear, water colored, attractively colored, or transparent.

With continuing reference to FIG. 1, the fishing bait pouch 101 is attached to the fishing hook 110 by inserting the fishing hook barb into a securing member 104 such as a ring or otherwise attaching the hook eye to the securing member 104 using a ring, split ring, clip, wire tie, twist tie, clamp, strap, belt, or Velcro®. A securing member 104 fixated to a frontal end of the pouch 101 may optionally be sized and constructed to secure the fishing hook 110 by pressing the point/barb 108 through the securing member 104. Alternately a securing split ring 104 may optionally be sized and constructed to secure the fishing hook 110 by enclosing or snapping the slip ring on the fishing hook shank 106 or eye 107 and locking it. Another exemplary embodiment of the securing ring 104 includes an elastomeric membrane molded or bonded to the ring to fully or partially cover the opening within the ring so that an inserted hook is positively retained as opposed to loosely retained as with open rings or split rings.

With continuing reference to FIG. 1, the fishing hook 110 is shown external to the fishing bait pouch 101. Optionally the fishing hook 110 can be secured partly or mostly inside of the bait pouch 101 to be in closer proximity to the bait 109 while not injuring it or penetrating it.

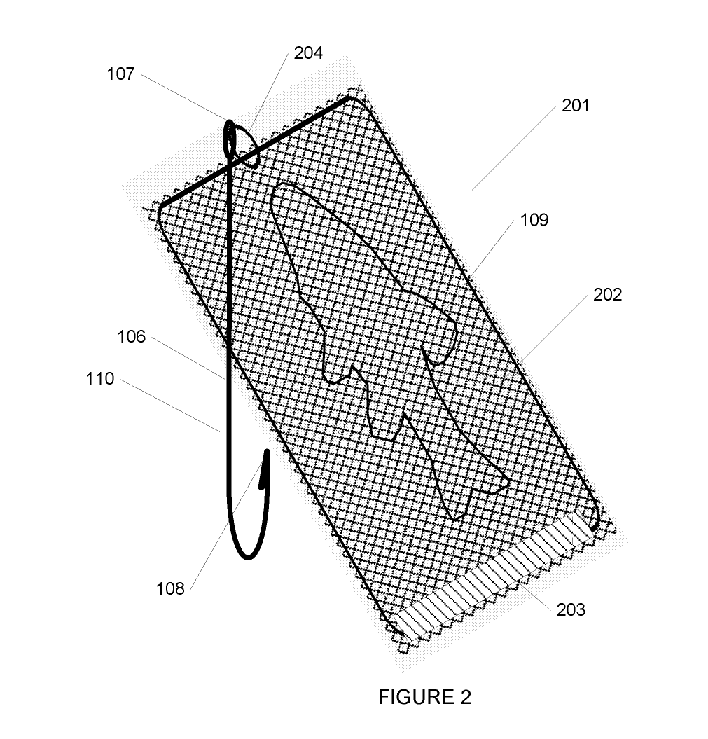

Referring to FIG. 2, a side view of fishing bait mesh pouch 201 is illustrated attached to a fish hook 110 at the fish hook eye 107 attached to securing member 204 such as a ring a ring, split ring, clip, wire tie, twist tie, clamp, strap, belt, or Velcro®. The fish hook 110 is shown external to the bait mesh pouch 201. Another exemplary embodiment of the securing ring 204 includes an elastomeric membrane molded or bonded to the ring to fully or partially cover the opening within the ring so that an inserted hook is positively retained as opposed to loosely retained as with open rings or split rings.

With continuing reference to FIG. 2, the fishing hook 110 can be secured partly or mostly inside of the bait pouch 201 to be in closer proximity to the bait 109 while not injuring it or penetrating it. The fishing bait pouch 201 facilitates an entry port 203 that is in the form of Velcro®, snap, wires, zipper, flap, wire tie, twist tie, wire hook, or draw string.

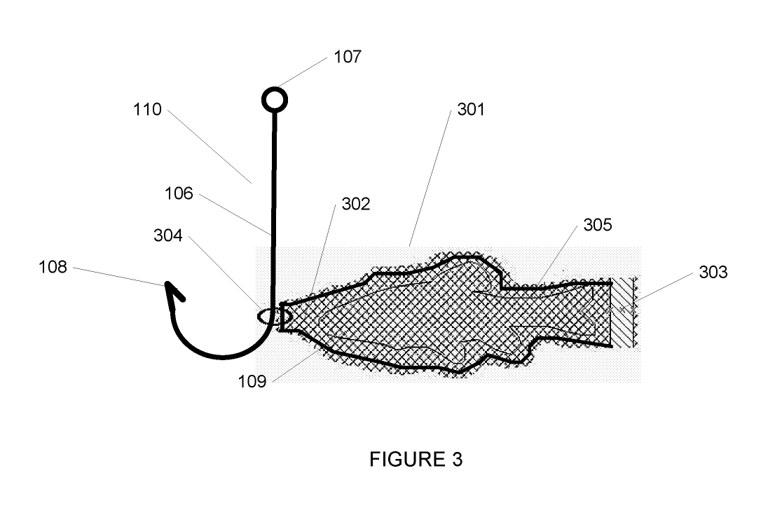

Referring to FIG. 3, a fishing bait mesh pouch 301 with a shape that is similar to that of the bait, an exemplary minnow, itself is illustrated and shown as attached to a fish hook 110 at the shank 106. The fish hook 110 is shown external to the bait mesh pouch 301.

With continuing reference to FIG. 3, the fishing hook 110 can be secured partly or mostly inside of the bait pouch 301 to be in closer proximity to the bait 109 while not injuring it or penetrating it.

With continuing reference to FIG. 3, the fishing bait shaped mesh pouch 301 is partially enclosed with a bait shaped seam 305 made by sewing an interweaved thread, a glue seam, a melted mesh seam, RF welded seam, or other seaming technique. The seam is shaped and sized along a perimeter for any shape or size of fish bait or for a specific shape. The seam provides a perimeter of and for the bait mesh pouch.

With continuing reference to FIG. 3, the fishing bait pouch 301 shows an entry port 303 that is in the form of Velcro®, snap, wires, zipper, flap, wire tie, twist tie, wire hook, or draw string. The entry port is used to facilitate the bait entry into the pouch 301.

With continuing reference to FIG. 3, the fishing bait pouch 301 is composed of a mesh that is flexible or stretchable so the bait 109 appears and feels as unobstructed. Furthermore, the mesh is optionally clear, water colored, attractively colored, or transparent.

With continuing reference to FIG. 3, the fishing bait pouch 301 is attached to the fishing hook 110 by ring, split ring, clip, clamp, wire tie, twist tie, strap, belt, Velcro®, or a suitable securing member 304. A securing member 304 may optionally be sized and constructed to secure the fishing hook 110 by pressing the point/barb 108 through the securing ring 304. Alternately a securing split ring 304 may optionally be sized and constructed to secure the fishing hook 110 by enclosing or snapping the slip ring on the fishing hook shank 106 or eye 107 and locking it. Another exemplary embodiment of the securing ring 304 includes an elastomeric membrane molded or bonded to the ring to fully or partially cover the opening within the ring so that an inserted hook is positively retained as opposed to loosely retained as with open rings or split rings.

With continuing reference to FIG. 3, the fishing hook 110 is shown external to the fishing bait shaped pouch 301. Optionally the fishing hook 110 can be secured partly or mostly inside of the bait shaped pouch 301 to be in closer proximity to the bait 109 while not injuring it or penetrating it.

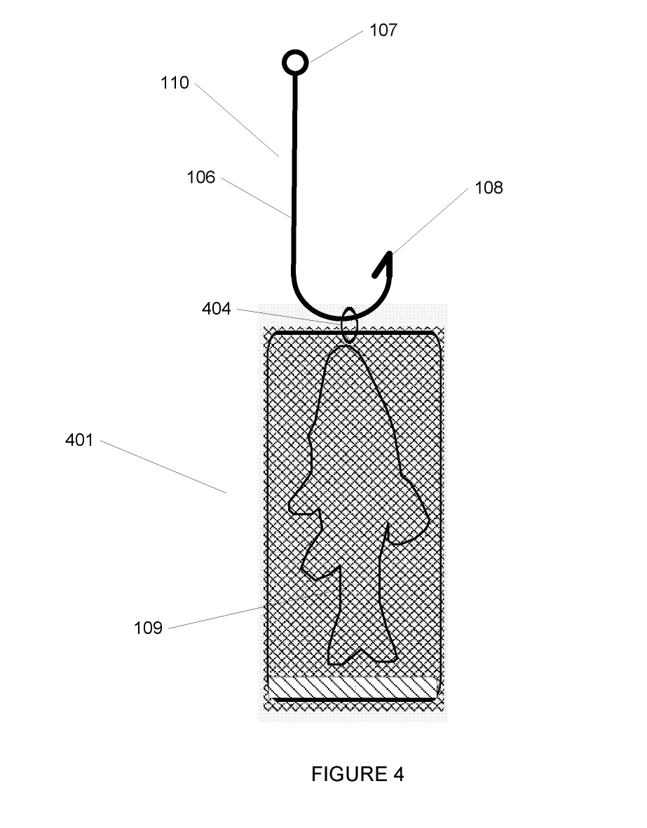

Referring to FIG. 4, a side view of fishing bait mesh pouch 401 is illustrated attached to a fish hook 110 at the bend. The fish hook 110 is shown in line and external to the bait mesh pouch 401.

With continuing reference to FIG. 4, the fishing hook 110 can be secured partly or mostly inside of the bait pouch 401 to be in closer proximity to the bait 109 while not injuring it or penetrating it.

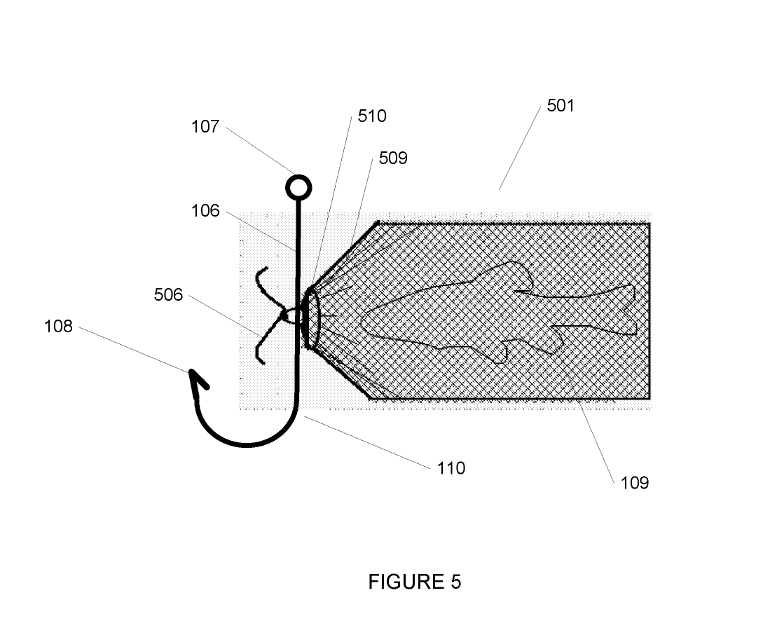

Referring to FIG. 5, a side view of fishing bait mesh pouch 501 is illustrated attached to a fish hook 110 at the shank. The fish hook 110 is shown external to the bait mesh pouch 401.

With continuing reference to FIG. 5, the fishing bait pouch 501 frontal entry port 510 is secured by pulling the draw string or twist tie 506 until the port is essentially closed with the bait 109 enclosed and secured. The draw string or twist tie 506 is also used to secure the fishing bait mesh pouch 501 to the fish hook 110.

With continuing reference to FIG. 5, the fishing bait pouch 501 is attached to the fishing hook 110 shank 106 by draw string, wire tie, or twist tie 506. The fishing bait pouch 501 is optionally attached to the fishing hook 110 eye 107 by draw string or twist tie 506.

With continuing reference to FIG. 5, the fishing hook 110 can be secured partly or mostly inside of the bait pouch 501 to be in closer proximity to the bait 109 while not injuring it or penetrating it.

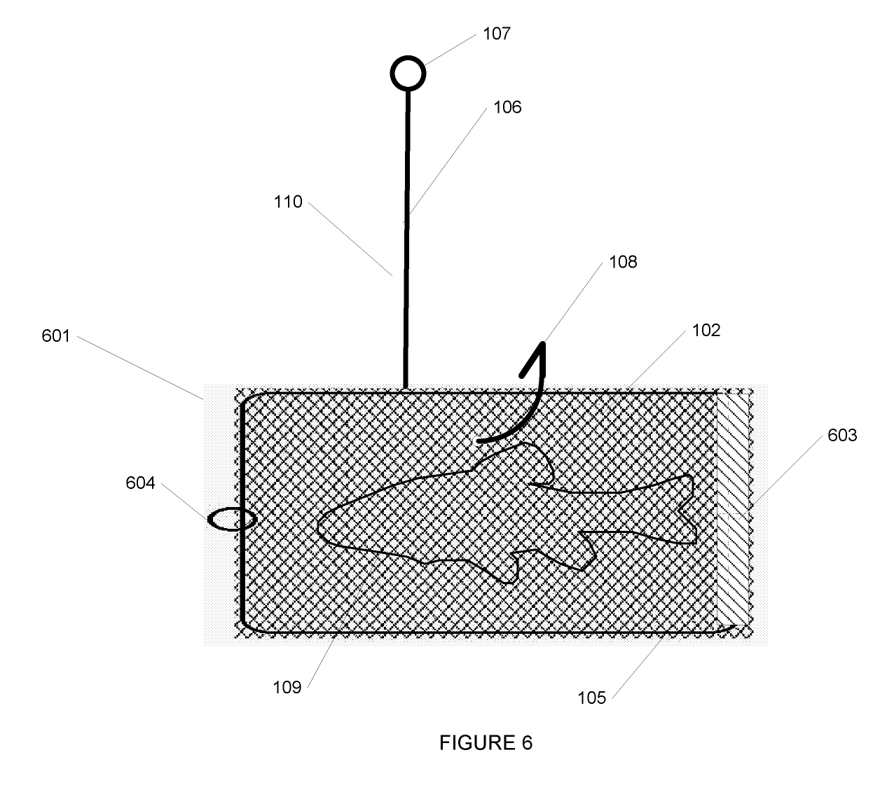

Referring to FIG. 6, a side view of fishing bait mesh pouch 601 is illustrated attached to a fish hook 110 by the penetration of the fishing hook 110 through the sides or walls of the pouch 601. The hook 110 optionally penetrate a designated area or zone having an alternate material selected for the ease of penetration or optimal penetration characteristics including but not limited to ruggedness or reliability. In this configuration the securing member 604 is not needed.

With continuing reference to FIG. 6, the fishing bait pouch 601 facilitates an entry port 603 that is optionally in the form of Velcro®, snap, wires, zipper, flap, wire tie, twist tie, wire hook, or draw string. The entry port is used to facilitate the bait entry (or exit) into or from the pouch 601.

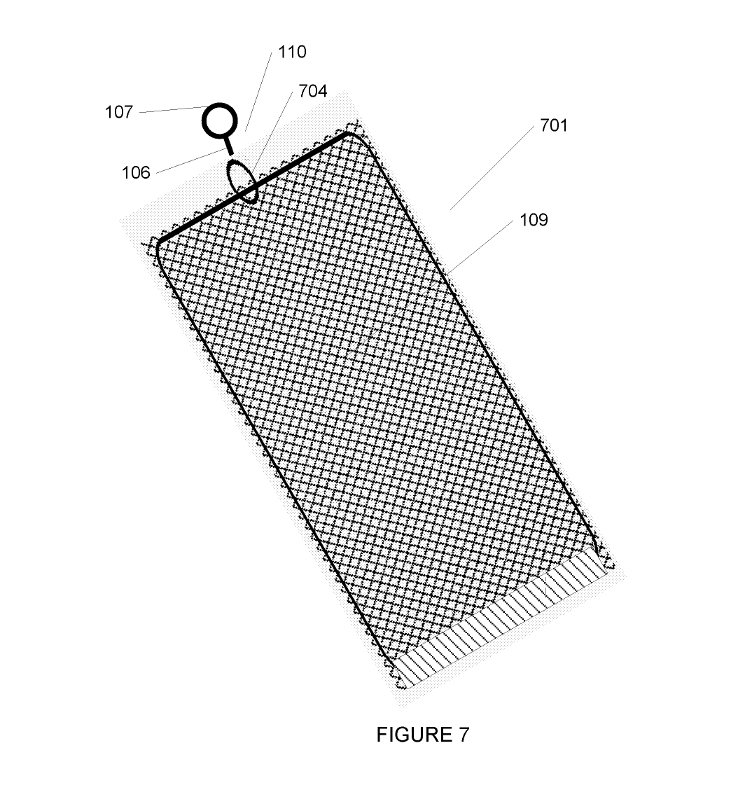

Referring to FIG. 7, a side view of fishing bait mesh pouch 701 is illustrated with fishing hook 110 internal to the pouch 701. The fishing hook 110 is secured to pouch 701 on the shank 106 or optionally at the eye 107.

With continuing reference to FIG. 7, the fishing bait pouch 701 is attached to the fishing hook 110 by ring, split ring, clip, clamp, wire tie, twist tie, strap, belt, Velcro®, or a suitable securing member 704. A securing member 704 may optionally be sized and constructed to secure the fishing hook 110 by pressing the point/barb 108 through the securing ring 704. Alternately a securing split ring 704 may optionally be sized and constructed to secure the fishing hook 110 by enclosing or snapping the slip ring on the fishing hook shank 106 or eye 107 and locking it. Another exemplary embodiment of the securing ring 704 includes an elastomeric membrane molded or bonded to the ring to fully or partially cover the opening within the ring so that an inserted hook is positively retained as opposed to loosely retained as with open rings or split rings.

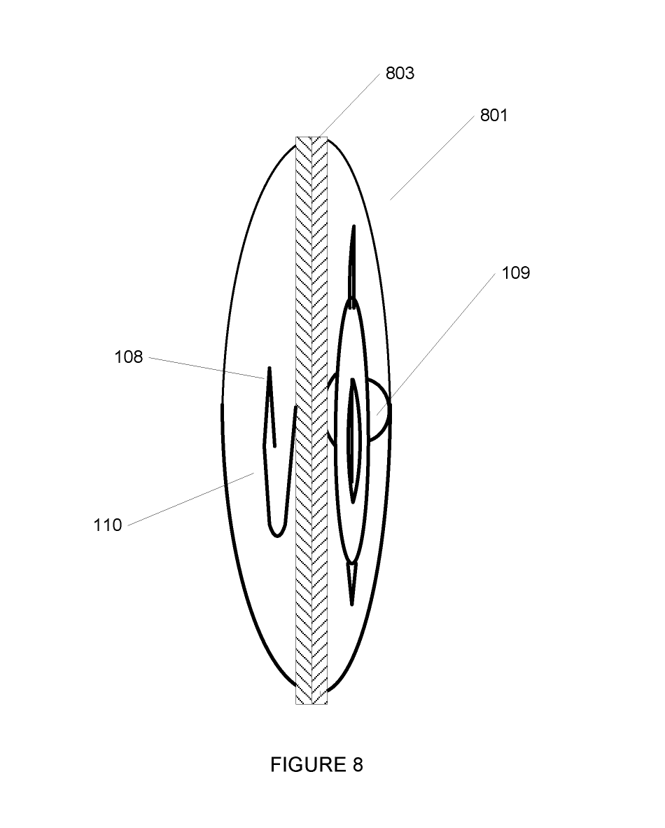

Referring to FIG. 8, a rear view of fishing bait mesh pouch 801 is illustrated with a partial view of fishing hook 110 including the point/barb 108 along with a rear view of fishing bait 109 inside the pouch 801.

With continuing reference to FIG. 8, the rear view fishing bait pouch 801 is facilitated by the rear entry port sealed and secured with member 803 that is in the form of Velcro®, snap, wires, zipper, flap, wire tie, twist tie, wire hook, or draw string.

With continuing reference to FIG. 1 through FIG. 8, fish bait or lure 109 may be initially alive or dead. The fish bait 109 may be a live minnow, bait fish, lizard, worm, crawfish, cricket, fly, or other live bait. A fishing bait mesh pouch extends the life of live bait since the fishing hook 110 does not injure or penetrate the live bait. Furthermore any non-live bait 109 including an artificial or previously alive minnow, bait fish, lizard, worm, crawfish, cricket, fly, or other life form bait is secured by the fishing bait mesh pouch 101 or 801. The fishing bait mesh pouch will optionally hold and secure any form of prepared or mixed bait such as dough balls or cut bait.

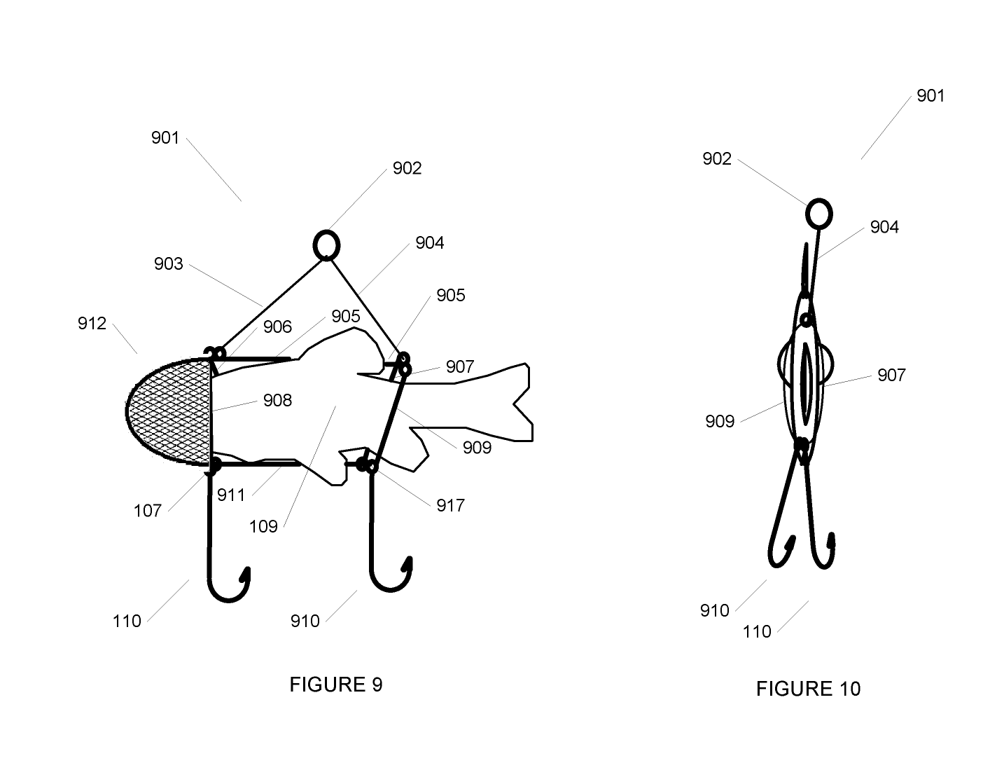

Referring to FIG. 9, a side view of an open frame fish bait holding apparatus 901 is illustrated as the primary fishing bait or lure 109 securing structure. Also illustrated are hooks 110 positioned at a front or mouth location to the bait 109 and 910 positioned at a rear or tail location. A partial mesh dome 912 is shown to secure the fishing bait at the front or mouth position. The bait harness 901 is secured to a fishing line at eye or ring 902 and suspended by at least one supporting or connecting member 903 and optionally a second member 904. With only connecting member 903 connected the bait harness 901 tends to move more horizontally under water as with reeling or trolling whereas with the second member 904 attached with an approximately equal sized connecting member 903 the bait harness 901 tends to move with undulations and more vertically underwater. Ratios of members 903 and 904 can be adjusted for varying bait harness behavior during reeling and trolling activities to attract fish.

With continuing reference to FIG. 9, a top longitudinal harness member 905 may be a rigid wire member to keep the bait 109 elongated or to keep the hooks 110 and 910 separated. A second embodiment for the top longitudinal harness member 905 is that of a flexible member such as a flexible wire to provide the bait 109 with more of a natural movement or to provide a softer feel to a biting fish or mammal being lured.

With continuing reference to FIG. 9, a front harness member 906 is constructed as a “C” shaped rigid member that partially fixates, including approximately half of a mesh dome 912 and arcs around the body shape of the bait 109 and terminates at the front hook 110, eye 107 to a front end of a bottom longitudinal harness member 911.

With reference to FIG. 10 and continuing reference to FIG. 9, a rear harness member 907 is constructed as a “C” shaped rigid member that arcs half way around the body shape of the fishing bait 109 and terminates at the rear hook 910, eye 917 to a front end of a bottom longitudinal harness member 911.

With continuing reference to FIG. 9, a front harness member 908 is constructed as a front elastic member to secure the bait 109 by providing a force to hold the bait 109 between rigid “C” member 906 and the front elastic member 908. Elastic member 908 is secured at the top and bottom ends of rigid “C” member 906. Front securing mesh dome is fixated along the perimeter of rigid “C” front harness member 906 optionally secured at the same top and bottom points along with the front elastic member 908.

With continuing reference to FIG. 9, a rear harness member 909 is constructed as a rear elastic member to secure the bait 109 by providing a force to hold the bait 109 between rigid “C” member 907 and rear elastic member 909. Rear elastic member 909 is secured at the top and bottom ends of rigid “C” rear harness member 907. The front and rear elastic members 908 and 909 respectively are detachable at optionally either end to facilitate an installation and holding of a fishing bait.

With continuing reference to FIG. 9, a front harness member 908 and a rear harness member 909 are secured at the bottom or belly side of the fishing bait 109 by a rigid or flexible bottom longitudinal harness member 911 such as a rigid or flexible wire respectively. A flexible bait harness member 911 provides the fishing bait 109 with more of a natural movement or to provide a softer feel to a biting fish or mammal being lured. A rigid bait harness member 911 is used to keep the bait 109 elongated and keep the hooks 110 and 910 from being entangled.

With reference to FIG. 10, a rear view of the baited fishing harness 901 is illustrated. The between rigid “C” member 907 and elastic member 909 are shown to be securing the bait 109 at the rear position. Not shown in FIG. 10, but similar in structure, is the configuration of rigid “C” member 906 and front elastic member 908 at the front section of the fishing bait 109.

The following paragraphs describe methods for installing and using fish bait holding apparatuses:

A method for installing a fishing bait 109 into a fish bait holding apparatus equally applying to other bait mesh pouch embodiments herein: using for example a combination of the bait mesh pouch 101, securing ring 104 and in certain cases, a fishing hook 110:

opening an entry port 103 of a bait mesh pouch;

placing a fishing bait 109 inside the bait mesh pouch 101;

closing the entry port 103 of the bait mesh pouch 101; and

attaching a fishing hook 110 to the bait mesh pouch 101 by one of inserting a fishing hook barb through a securing ring 104 or the sides 102 of the bait mesh pouch 101.

A method for installing fishing bait 109 into an open frame fish bait holding apparatus 901 including:

disconnecting a front elastic member 908 of a front harness 906 and a rear elastic member 909 of a rear harness member 907;

placing a fishing bait 109 inside the head first into a partial mesh dome within the front harness member and the rear of the fish bait into the rear harness; and

reconnecting the front elastic member of the front harness and the rear elastic member of the rear harness to install the fishing bait.

That which is claimed:

1. A fish bait holding apparatus comprising:
a bait mesh pouch comprised of a mesh material wherein the bait mesh pouch is partially enclosed with a seam and further comprised of an entry port; and
a securing member fixated at a frontal end of the bait mesh pouch for attachment to a fishing hook.

2. The fish bait holding apparatus of claim 1, wherein the fishing hook is attached to the bait mesh pouch by inserting the fishing hook into the securing member.

3. The fish bait holding apparatus of claim 1, wherein the fishing hook is attached to the bait mesh pouch by inserting the fishing hook through the mesh material of the bait pouch.

4. The fish bait holding apparatus of claim 1, wherein the fishing hook is attached to the bait mesh pouch by attaching a fishing hook eye to the securing member.

5. The fish bait holding apparatus of claim 4, wherein the fishing hook is attached to the bait mesh pouch by attaching a fishing hook eye to the securing member comprising one of a ring, split ring, clip, wire tie, twist tie, clamp, strap, belt, or Velcro®.

6. The fish bait holding apparatus of claim 1, wherein the entry port of the bait mesh pouch is comprised of one of a waterproof glue, Velcro®, snap, wires, zipper, flap, wire tie, twist tie, wire hook, or draw string attached to the bait mesh pouch.

7. The fish bait holding apparatus of claim 6, wherein the entry port of the bait mesh pouch faces either a rear or the front side of the bait mesh pouch relative to an enclosed or entrapped bait orientation or a position of the attached fishing hook.

8. The fish bait holding apparatus of claim 1, wherein the seam provides a perimeter of the bait mesh pouch and comprises a shape corresponding to a rectangle.

9. The fish bait holding apparatus of claim 1, wherein the seam provides a perimeter of the bait mesh pouch and comprises a shape corresponding to a live bait.

10. The fish bait holding apparatus of claim 9, wherein the live bait is a minnow.

11. The fish bait holding apparatus of claim 1, wherein the fishing hook is internal to the bait mesh pouch and is attached to the bait mesh pouch by inserting the fishing hook into the securing member.

12. An open frame fish bait holding apparatus comprising:
a mesh dome to secure the fishing bait at the front or mouth position;
a bait harness comprising:
a ring for securing to a fishing line at the bait harness;
an at least one connecting member for suspending the bait harness;
a top longitudinal harness member for structural support and keeping the fishing bait elongated;
a bottom longitudinal harness member for structural support and keeping the fishing bait elongated;
a front C shaped rigid member that arcs half way around a front body shape of a bait and fixates half of the mesh dome as it arcs until a top end and a bottom end of the front C shaped rigid member are reached:
wherein the top end of the front C shaped rigid member terminates with a front end of the top longitudinal harness member;
wherein a bottom end of the front C shaped rigid member terminates with a front end of the bottom longitudinal harness member and an eye of a front fishing hook;
wherein a front elastic member is attached to the top and bottom ends of the front C shaped rigid member providing a force between the front C shaped rigid member and the front elastic member for holding a front end of an installed bait;
a rear C shaped rigid member that arcs half way around a rear body shape of a bait until a top end and a bottom end of the rear C shaped rigid member are reached:
wherein the top end of the rear C shaped rigid member terminates with a rear end of the top longitudinal harness member;
wherein the bottom end of the rear C shaped rigid member terminates with a rear end of the bottom longitudinal harness member and the eye of a rear fishing hook;
wherein a rear elastic member is attached to the top and bottom ends of the rear C shaped rigid member providing a force between the rear C shaped rigid member and rear elastic member for holding a rear end of an installed bait;

13. The open frame fish bait holding apparatus of claim 1 wherein the top and bottom longitudinal harness members are comprised of rigid wire.

14. The open frame fish bait holding apparatus of claim 1 wherein the top and bottom longitudinal harness members are comprised of flexible wire.

15. The open frame fish bait holding apparatus of claim 1 wherein the front and rear elastic members are optionally detachable at either end to facilitate an installation and holding of a fish bait.

16. A method for installing a fishing bait into a fish bait holding apparatus of claim 1 comprising:
opening an entry port of a bait mesh pouch;
placing a fishing bait inside the bait mesh pouch;
closing the entry port of the bait mesh pouch; and
attaching a fishing hook to the bait mesh pouch by one of inserting a fishing hook barb through a securing ring or the sides of the bait mesh pouch.

17. A method for installing a fishing bait into an open frame fish bait holding apparatus of claim 12 comprising:
disconnecting a front elastic member of a front harness and a rear elastic member of a rear harness;
placing a fishing bait inside the head first into a partial mesh dome within the front harness member and the rear of the fish bait into the rear harness; and
reconnecting the front elastic member of the front harness and the rear elastic member of the rear harness to install the fishing bait.
